(19) United States
(12) Patent Application Publication
(10) Pub. No.: US 2008/0196024 A1
(43) Pub. Date: Aug. 14, 2008

(54) Method and Apparatus for Changing Software Components in an Information Handling System

(75) Inventors: Janel Guillory Barfield, Round Rock, TX (US); Eric Philip Fried, Austin, TX (US); Joseph Vernon Lampitt, Seattle, WA (US); Kevin William Monroe, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/672,577

(22) Filed: Feb. 8, 2007

(51) Int. Cl. G06F 9/445

(52) U.S. Cl. 717/177

(57) ABSTRACT

A client information handling system (IHS) includes a dependency database that stores both installation dependency information and operational dependency information for installed software components and candidate software components. The client IHS also includes a request handler that, in response to a request to change the software configuration of the IHS, checks the dependency database for conflicts between a candidate software component and both installation and operational dependencies that the dependency database stores.

### TECHNICAL FIELD OF THE INVENTION

The disclosures herein relate generally to information handling systems, and more particularly to altering the software configuration of an information handling system.

### BACKGROUND

Information handling systems (IHSs) typically include many installed software components or applications, such as word processors, spreadsheets, data bases, presentation tools, web browsers, email applications, utilities and games, just to name a few. In an ideal world, when you install a new software component on an IHS, the new software component would not conflict or interfere with an already installed software component. Unfortunately, this is not always the case.

Problems may arise when a user installs a new software component due to “installation dependencies”, namely a dependency wherein the installation or operation of a new software component depends on the installation status of a component already present on the IHS. An example of an installation dependency is the scenario where a user cannot install software component A unless software component B already exists on the IHS.

Problems may also arise when a user installs a new software component due to “operational dependencies”, namely a dependency wherein the installation or operation of a new software component depends on the operational status, i.e. running status, of another software component. Operational status refers to whether or not an IHS currently runs or executes a particular software component or application. An example of an operational dependency is the scenario where software component A is not installable on an IHS during those times when software component B runs on the IHS. Another example of an operational dependency is the situation where software component A will not run on an IHS while software component B runs on the IHS. This problem may occur when software component B is a daemon component. The conventional “installp” program and the conventional RPM Linux installation program handle installation dependencies. However, operational dependencies among software components remain a problem.

In many businesses, educational institutions, government organizations and other entities that employ multiple networked IHSs, a network administrator must often determine if installation dependencies and/or operational dependencies exist before installing new software components. This can be a very burdensome task. Some software component vendors prepare custom scripts to check for operational dependencies that execute at installation time and runtime. The goal of these scripts is to relieve the network administrator from some dependency checking. For example, if software component A is not installable while software component B runs, the vendor of software component A may prepare a custom script in the package with component A to make sure that component B does not run while component A operates. This custom script runs when component A installs. In one approach, the script may tell the IHS user of the dependency and instruct the user to terminate component B so component A may run.

Unfortunately, the script method described above requires that the software component developer or vendor know all operational dependencies of their product prior to product release to the marketplace. Moreover, this approach requires a custom script or custom user documentation for each software component product. Requiring a software vendor of component A to know all operation dependencies with respect to all other software programs is not realistic. While extensive and lengthy testing may reveal operational dependencies of software component A with respect to other existing software components B, it is not possible to check for operational dependencies against a future product B that is not yet in the marketplace. To handle the other type of dependency, namely installation dependencies, some IHSs include a native software repository or database that tracks installation relationships among multiple software components in a multiple hosting environment, for example the operating system and a Java environment.

What is needed is a method and apparatus that addresses the software configuration change problems discussed above.

### SUMMARY

Accordingly, in one embodiment, a method is disclosed for changing a software configuration of an information handling system (IHS). The method includes installing a plurality of software components in the IHS, thus providing the IHS with a first software configuration including installed software components. The method also includes storing in the IHS a local database including installation dependencies and operational dependencies of installed software components and candidate software components. The method further includes receiving, by a request handler in the IHS, a request to change the first software configuration of the IHS to a second software configuration. The method also includes checking, by the request handler, the local database to determine if the request to change the first software configuration to the second software configuration conflicts with an installation dependency or an operational dependency. The request handler prevents the second software configuration if the request handler finds a conflict. Alternatively, the request handier allows the second software configuration if the request handler finds no conflict.

In another embodiment, an information handling system (IHS) is disclosed that includes a processor and a memory coupled to the processor. The information handling system also includes a data store coupled to the processor. The data store includes a plurality of installed software components that provide the IHS with a first software configuration. The data store also includes a local database including installation dependencies and operational dependencies of installed software components and candidate software components. The data store further includes a request handler that receives a request to change the first software configuration of the IHS to a second software configuration. The request handler checks the local database to determine if the request to change the first software configuration to the second software configuration conflicts with an installation dependency or an operational dependency. The request handler prevents the second software configuration if the request handler finds a conflict. Alternatively, the request handler allows the second software configuration if the request handler finds no conflict.

In yet another embodiment, a computer program product is disclosed that is stored on a computer operable medium. The computer program product handles requests for changes to a software configuration of an information handling system (IHS). The computer program product includes a local database including installation dependencies and operational dependencies of installed software components and candidate software components. The computer program product also includes a request handler including instructions for receiving a request to change a first software configuration of the IHS to a second software configuration. The request handler further includes instructions for checking the local database to determine if the request to change the first software configuration to the second software configuration conflicts with an installation dependency or an operational dependency. The request handler includes instructions for preventing the second software configuration if the request handler finds a conflict. The request handler also includes instructions for allowing the second software configuration if the request handler finds no conflict.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed system that includes a client information handling system (IHS) coupled via a network to master dependency databases.

FIG. 2 is a representative local client dependency database that the IHS of FIG. 1 employs.

FIG. 3 shows a flowchart that depicts the methodology that a request handler application in the client IHS employs to handle requests for software configuration change.

### DETAILED DESCRIPTION

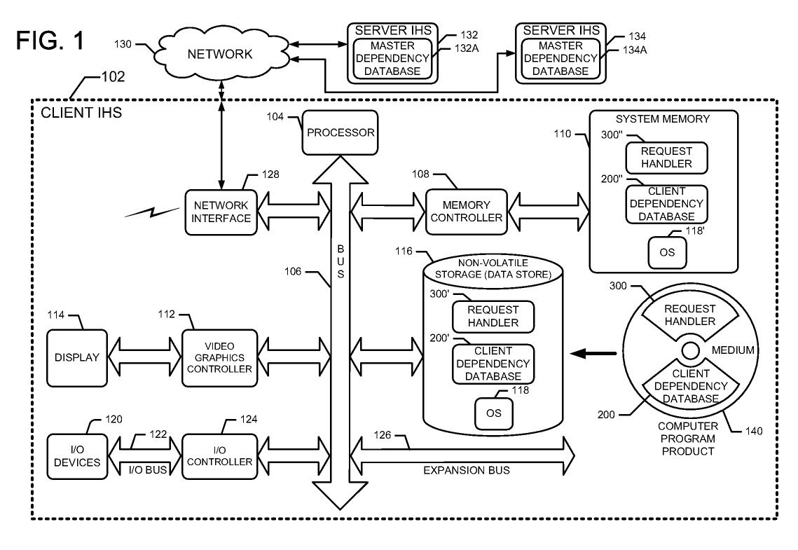

FIG. 1 shows a block diagram of a client information handling system (IHS) 102 that employs the disclosed methodology to manage requests for changes to the software configuration of the IHS. The current software configuration of the IHS refers to the particular combination of already installed software components in the IHS. In one embodiment, a software component may be an entire software application or a portion of a software application. Requests for changes to the current software configuration of IHS 102 include requests for software component installation, requests for software component upgrade and requests for software component removal. The modified software configuration of the IHS refers to the software configuration of the IHS after a request for change causes the installation, upgrade or removal of a software component on the IHS. The term candidate software component refers to the subject of a request for change before that software component receives approval or disapproval for installation, updating or removal. For example, if a user attempts to install a software component in IHS 102, then that particular software application is a candidate software component. In deciding whether or not to carry out a particular request for change to the software configuration of the IHS, the disclosed methodology considers both installation dependencies and operational dependencies that the candidate software component may exhibit with respect to the current software configuration of the IHS, namely the already installed software components of the IHS.

Client IHS 102 includes a processor 104 that couples to a bus 106. A memory controller 108 couples system memory 110 to bus 106. A video graphics controller 112 couples display 114 to bus 110. Client IHS 102 includes nonvolatile storage 116, such as a hard disk drive, CD drive, DVD drive, or other nonvolatile storage that couples to bus 106 to provide client IHS 102 with permanent storage of information. Nonvolatile storage 116 is a form of data store. An operating system (OS) 118 loads from nonvolatile storage 116 to memory 110 as OS 118′ to govern the operation of client IHS 102. I/O devices 120, such as a keyboard and a mouse pointing device, couple via I/O bus 122 and I/O controller 124 to bus 106. One or more expansion busses 126, such as USB, IEEE 1394 bus, ATA, SATA, PCI, PCIE and other busses, couple to bus 106 to facilitate the connection of peripherals and devices to client IHS 102. A network interface 128 couples to bus 106 to enable client IHS 102 to connect by wire or wirelessly to network 130 and other IHSs such as server IHS 132 and/or server IHS 134. Network 130 may be a local area network (LAN), a wide area network (WAN), an internet protocol (IP) network, or other connective apparatus. Client IHS 102 may take many forms. For example, client IHS 102 may take the form of a desktop, server, portable, laptop, notebook, or other form factor computer or data processing system. Client IHS 102 may also take other form factors such as a personal digital assistant (PDA), a gaming device, a portable telephone device, a communication device or other devices that include a processor and memory.

Client IHS 102 employs a client dependency database 200 and a request handler application 300 to determine if client IHS 102 may carry out a request for software component change without causing problems to client IHS 102. These problems include the candidate software component interfering with the operation of software components already installed on client IHS 102, and also include the already installed software components interfering with the installation or operation of the candidate software component. In one embodiment, a medium 140 stores client dependency database 200 and request handler application 300 as computer program products prior to the installation of these applications on client IHS 102. The term database denotes a data structure that includes information such as dependency information. Client IHS 102 may employ a compact disk (CD), digital versatile disk (DVD), floppy disk, external hard disk or virtually any other digital storage medium as medium 140. A user or other entity installs client dependency database 200 and request handler application 300 on client IHS 102 prior to usage of these applications. The designation, request handler 300′, describes request handler 300 after installation on client IHS 102. The designation, client dependency database 200′ or local database 200′, describes client dependency database 200 after installation on client IHS 102. The designation, client dependency database 200″, describes client dependency database 200′ after client IHS 102 loads the client database into system memory 110 for execution. The designation, request handler 300″, describes request handler 300 after client IHS 102 loads the request handler into system memory 110 for execution.

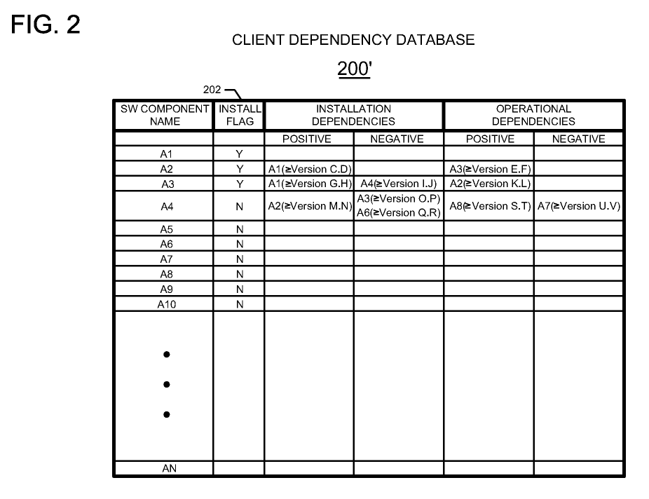

Client dependency database 200′ is a database that stores dependency information relating to the installed software components of client IHS 102 as well as candidate software components not yet installed on client IHS 102. In one embodiment shown in FIG. 2, database 200′ includes an entry for each installed software component of client IHS 102. In this particular example, software components A1, A2 and A3 represent the installed programs of client IHS 102. In actual practice, client IHS 102 may include a much higher number of installed software components or applications than this example. For each installed software component, the install flag 202 is set to a value Y, as shown in FIG. 2. Database 200′ also includes entries for other software components A4, A5, A6 . . . AN, that a user or other entity may later attempt to install on client IHS 102. Such other entries are candidate software components. For each of these uninstalled software components, the install flag 202 is set to a value N, as shown in FIG. 2. In this usage, “N” means “not installed” and “Y” means “already installed”. The designation “AN” refers to the last software component entry in client dependency database 200′ as seen in the “Software (SW) Component Name” column of the client dependency database of FIG. 2.

Referring now to the installed software components or applications A1, A2 and A3 in FIG. 2, software component A1 is the first application installed in client IHS 102. The “Y” in the A1 row indicates the installed status of software component A1, namely that IHS 102 includes software component A1 among its installed software components or applications. Studying the remainder of the software component A1 row, this software component A1 exhibits no positive or negative installation dependencies. Moreover, software component A1 exhibits no positive or negative operational dependencies. In one embodiment, software component A1 may be a word processor application, a spreadsheet application, a presentation application or virtually any other software application that exhibits no installation dependencies or operational dependencies.

In the example of FIG. 2, the software component A2 row shows that software component A2 exhibits an installed status because the install flag exhibits a “Y” value. The software component A2 row also shows that software component A2 exhibits a positive installation dependency on software component A1 (Version C.D or greater), wherein C and D are integers describing the version number of the software component A1. For example, if C=2 and D=5, then the software component A2 row exhibits a positive dependency on software component A1 (Version 2.5 or greater). This positive installation dependency of software component A2 on software component A1 (Version C.D or greater) means that the installation or operation of software component A2 requires the prior installation of software component A1 (Version C.D or greater) on client IHS 102. In other words, software component A1 (Version C.D or greater) must already exhibit an “installed status” before an attempted installation of software component A2. In this example, the software component A2 row also shows that software component A2 exhibits a positive operational dependency on software component A3 (Version E.F or greater), wherein E and F are integers describing the version number of the software component A3. This positive operational dependency of software component A2 on software component A3 (Version E.F or greater) means that the installation or operation of software component A2 depends on the “running status” of software component A3 (Version E.F or greater). In other words, to enable software component A2 to install or operate, software component A3 (Version E.F or greater) must exhibit a positive running status, namely software component A3 (Version E.F or greater) loads and executes in system memory 110 before software component A2 will install or operate.

In the example of FIG. 2, the software component A3 row shows that software component A3 exhibits an installed status because the install flag exhibits a “Y” value. The software component A3 row also shows that software component A3 exhibits a positive installation dependency on software component A1 (Version G.H or greater), wherein G and H are integers describing the version number of the software component A1. This positive installation dependency of software component A3 on software component A1 (Version G.H or greater) means that the installation or operation of software component A3 requires the prior installation of software component A1 (Version G.H or greater) on client IHS 102. In other words, software component A1 (Version G.H or greater) must already exhibit an “installed status” before an attempted installation of software component A3. In this example, the software component A3 row also shows that software component A3 exhibits a negative installation dependency on software component A4 (Version I.J or greater), wherein I and J are integers describing the version number of the software component A4. With respect to software component A4, I≧0 and J≧0 such that software component A4 may include Versions 0.0 and greater This negative installation dependency of software component A3 on software component A4 (Version I.J or greater) means that software component A3 will not install or operate properly if software component A4 (Version I.J or greater) is present with an installed status on client IHS 102. In this example, the software component A3 row also shows that software component A3 exhibits a positive operational dependency on software component A2 (Version K.L or greater). This positive operational dependency of software component A3 on software component A2 (Version K.L or greater) means that the installation or operation of software component A3 depends on the “running status” of software component A2 (Version K.L or greater). In other words, to enable software component A3 to install or operate, software component A2 (Version K.L or greater) must exhibit a positive running status, namely software component A2 (Version K.L or greater) loads and executes in system memory 110 before software component A3 will install or operate.

In the example of FIG. 2, the software component A4 row shows that software component A4 exhibits a not-installed or un-installed status because the install flag exhibits a “N” value. This means that software component A4 is a candidate software component because a user or other entity did not yet install software component A4 on client IHS 102. However, should a user in the future submit a request for software configuration change to client 102 that calls for the installation of software component A4, client dependency database 200′ already stores installation and operational dependency information that will assist in the installation and/or operation of software component A4 on client IHS 102. More particularly, the software component A4 row stores a positive software component A2 installation dependency and further stores negative software component A3 and A6 operational dependencies. This means that before software component A4 can install or operate on client IHS 102, a user or other entity must first install software component A2 (Version M.N or greater) on client IHS 102, wherein M and N are integers describing the version number of the software component A2. Moreover, before software component A4 can install or operate on client IHS 102, client IHS 102 must not have software component A3 (Version O.P or greater) or software component A6 (Version Q.R or greater) installed thereon. The software component A4 row also shows that software component A4 exhibits a positive operational dependency on software component A8 (Version S.T or greater). This positive operational dependency of software component A4 on software component A8 (Version S.T or greater) means that the installation or operation of software component A4 depends on the “running status” of software component A8 (Version S.T or greater). In other words, to enable software component A4 to install or operate, software component A8 (Version S.T or greater) must exhibit a positive running status, namely software component AS (Version S.T or greater) loads and executes in system memory 110 before software component A4 will install or operate. The software component A4 row further shows that software component A4 exhibits a negative operational dependency on software component A7 (Version U.V or greater). This negative operational dependency of software component A4 on software component A7 (Version U.V or greater) means that the installation or operation of software component A4 depends on the “running status” of software component A7 (Version U.V or greater) in the sense that software component A7 (Version U.V or greater) is not currently running on client IHS 102. In other words, to enable software component A4 to install or operate, software component A7 (Version U.V or greater) must exhibit a negative running status, namely software component A7 (Version U.V or greater) does not load or execute in system memory 110 prior to installation or operation of software component A4 on client IHS 102. In the above examples, O, P, Q, R, S, T, U and V are integers that designate the software component version.

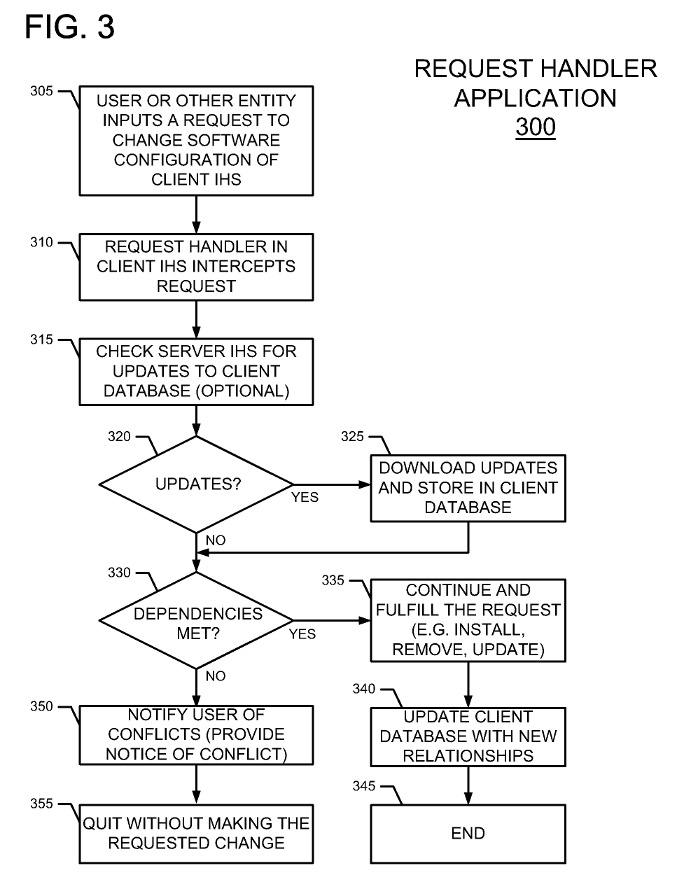

FIG. 3 is a flowchart that depicts representative process steps of a request handler application 300 that handles requests to change the software configuration of client IHS 102. When a user or other entity desires to install a software component, update a software component or remove an already installed software component from client IHS 102, the user or other entity inputs a request for software configuration change to IHS 102, as per block 305. This request for software configuration change is a request for software component change. For example, a user may desire to install a new software component A4 on client IHS 102. Referring to FIG. 2, the N in the software component A4 row of database 200′ indicates that software component A4 currently exhibits an uninstalled status on client IHS 102. When the user or other entity submits the request for software component change to client IHS 102, request handler application 300″ intercepts the request, as per block 310. The designation, request handler application 300″, indicates that the request handler application loads and executes in system memory 110 in accordance with the disclosed methodology.

After intercepting the request for software component change, request handler 300″ may optionally check a master dependency database 132A in server IHS 132 to determine if any updates are available that indicate dependencies not already indicated in client dependency database 200″. In one embodiment, a particular vendor, such as a hardware manufacturer, may maintain master dependency database 132A. As the vendor becomes aware of more dependencies that particular software components exhibit with respect to other software components, the vendor updates master dependency database 132A to reflect these newly discovered dependencies. In one embodiment, master dependency database 132A exhibits a layout and structure similar to client dependency database 200′ of FIG. 2 except with the install flag 202 omitted. In another embodiment, more than one master dependency database may track software components and their respective dependencies. For example, as shown in FIG. 1, server IHS 134 includes another master dependency database 134A that stores dependency information for particular software components.

Request handler 300″ conducts a test at decision block 320 to determine if updates exist for the software components in dependency database 200″. Request handler 300″ performs this test by accessing master dependency database 132A and/or master dependency database 134A. If request handler 300″ finds such updates, then request handler 300″ downloads the updates and stores the updates in client dependency database 200′, as per block 325. An update includes the software component name or other identifier and the associated dependencies such as any positive or negative installation dependencies and any positive or negative operational dependencies all in the entry format shown in FIG. 2. In one embodiment, master dependency database 132A and/or master dependency database 134A may push updates to client dependency database 200′ of client IHS 102. Alternatively, client dependency database 200′ may periodically pull updates from master dependency database 132A and/or master dependency database 134A.

After downloading any available dependency updates, request handler 300″ check to see if all dependencies are met, as per decision block 330. In the subject example, the user requests installation of a new software component A4 such as a multi-media software application. By checking the install flag of the software component A4 row, namely “N” in this case, request handler 300″ sees that software component A4 currently exhibits the uninstalled status. Software component A4 is a candidate software component. To check for dependencies of software component A4, request handler 300″ accesses the installation and operational dependencies that the software component A4 rows stores in client dependency database 200′. Dependency database 200′ shows that software component A4 exhibits a positive installation dependency with respect to software component A2 and further exhibits negative installation dependencies with respect to both software components A3 and A6. In one embodiment, request handler application 300 checks all client dependency database entries for any negative or positive dependencies for software component A4 to assure that all dependencies are met, i.e. no conflicts between software components exist, before allowing a software configuration change. Software component A4 also exhibits a positive operational dependency with respect to software component A8 and a negative operational dependency with respect to software component A7. If the current software component configuration of client IHS 102 meets all of these installation and operational dependencies, then process flow continues and request handler 300′ allows client IHS to perform the requested software configuration change, namely installing software component A4 in this particular example, as per block 335. Request handler 300′ then updates client dependency database 200′ to indicate the software component A4 now exhibits the installed status “Y”, as per block 340. Process flow then stops at end block 345. Alternatively, process flow may continue from block 340 back to block 305 at which the request handler 300′ waits for another request to update the software configuration of client IHS 102.

Returning now to decision block 330, if the current software configuration does not meet all dependencies for software component A4 in the A4 row of client dependency database 200′, then request handler 300″ notifies the user or other entity of the conflict that exists between the candidate software component A4 and other software components, as per block 350. In one embodiment, the notice to the user may specify that a dependency conflict exists between software component A4 and a particular software component or components. For example, request handler 300′ may provide such notice to the user by displaying the dependency conflict on display 114. Process flow then ends without performing the requested software configuration change, as per block 355. In other words, the process ends with the denial of installation of candidate software component A4 in this particular example. Alternatively, process flow may continue from block 350 back to block 305 at which the request handler 300′ waits for another request to update the software configuration of client IHS 102. In an alternative embodiment, client IHS 102 may perform the dependency test of decision block 330 by accessing dependency information in master dependency database 132A or master dependency database 134A. In that embodiment, it is still desirable to store dependency information in client IHS 102. In that embodiment, client IHS 102 may omit check for updates decision block 320 and download updates block 325.

Those skilled in the art will appreciate that the various structures disclosed can be implemented in hardware or software. Moreover, the methodology represented by the blocks of the flowchart of FIG. 3 may be embodied in a computer program product, such as a media disk, media drive or other media storage such as computer program product medium 140 of FIG. 1.

In one embodiment, the disclosed methodology is implemented as a client request handler application, namely sets of instructions (program code) in a code module which may, for example, be resident in system memory 110 of client IHS 102 of FIG. 1. Until required by client IHS 102, the set of instructions may be stored in another memory, for example, non-volatile storage 116 such as a hard disk drive, or in a removable memory such as an optical disk or floppy disk, or downloaded via the Internet or other computer network. Thus, the disclosed methodology may be implemented in a computer program product for use in a computer such as client IHS 102. It is noted that in such a software embodiment, code that carries out the functions depicted in the FIG. 3 flow chart may be stored in system memory 110 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses a methodology and apparatus that checks for both installation dependencies and operational dependencies before changing the software configuration of a client IHS.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method for changing a software configuration of an information handling system (IHS), the method comprising:
installing a plurality of software components in the IHS, thus providing the IHS with a first software configuration including installed software components;
storing in the IHS a local database including installation dependencies and operational dependencies of installed software components and candidate software components;
receiving, by a request handler in the IHS, a request to change the first software configuration of the IHS to a second software configuration; and
checking, by the request handler, the local database to determine if the request to change the first software configuration to the second software configuration conflicts with an installation dependency or an operational dependency, the request handler preventing the second software configuration if the request handler finds a conflict, the request handler allowing the second software configuration if the request handier finds no conflict.

2. The method of claim 1, wherein the request to change is one of a request to install a candidate software component on the IHS, a request to update a software component already installed on the IHS with a candidate component, and a request to remove a software component already installed on the IHS.

3. The method of claim 1, wherein the plurality of software components includes a software application.

4. The method of claim 1, further comprising updating the local database with installation dependencies and operational dependencies prior to the checking step.

5. The method of claim 4, wherein the IHS performs the updating step in response to receipt of the request for change.

6. The method of claim 4, wherein the IHS periodically monitors a master dependency database in a server IHS for updates to the installation and operational dependencies in the local database.

7. The method of claim 1, wherein the installation and operational dependencies include one of a positive dependency and a negative dependency.

8. The method of claim 2, further comprising providing a notice, by the request handler, that the candidate software component conflicts with an installation dependency or an operational dependency when the request handler finds a conflict.

9. The method of claim 1, wherein the request to change is a request to install a candidate software component, and the checking step includes preventing installation of the candidate software component if the request handler finds a conflict, the request handler allowing installation of the candidate software component if the request handler finds no conflict.

10. An information handling system (IHS), comprising:
a processor;
a memory, coupled to the processor;
a data store, coupled to the processor, the data store including:
a plurality of installed software components that provide the IHS with a first software configuration;
a local database including installation dependencies and operational dependencies of installed software components and candidate software components; and
a request handler that receives a request to change the first software configuration of the IHS to a second software configuration, the request handler checking the local database to determine if the request to change the first software configuration to the second software configuration conflicts with an installation dependency or an operational dependency, the request handler preventing the second software configuration if the request handler finds a conflict, the request handler allowing the second software configuration if the request handler finds no conflict.

11. The IHS of claim 10, wherein the request to change is one of a request to install a candidate software component on the IHS, a request to update a software component already installed on the IHS with a candidate component, and a request to remove a software component already installed on the IHS.

12. The IHS of claim 10, wherein the plurality of software components includes a software application.

13. The IHS of claim 10, wherein the request handler updates the local database with installation dependencies and operational dependencies.

14. The IHS of claim 13, wherein the IHS periodically monitors a master dependency database in a server IHS for updates to the installation and operational dependencies in the local database.

15. The IHS of claim 10, wherein the installation and operational dependencies include one of a positive dependency and a negative dependency.

16. The IHS of claim 10, further comprising a display on which the request handler provides a notice that the candidate software component conflicts with an installation dependency or an operational dependency when the request handler finds a conflict.

17. The IHS of claim 11, wherein the request to change is a request to install a candidate software component, the request handler preventing installation of the candidate software component if the request handler finds a conflict, the request handler allowing installation of the candidate software component if the request handler finds no conflict.

18. A computer program product stored on a computer operable medium for handling updates to a software configuration of an information handling system (IHS), the computer program product comprising:
a local database including installation dependencies and operational dependencies of installed software components and candidate software components; and
a request handler including instructions for receiving a request to change a first software configuration of the IHS to a second software configuration, the request handler checking the local database to determine if the request to change the first software configuration to the second software configuration conflicts with an installation dependency or an operational dependency, the request handler preventing the second software configuration if the request handler finds a conflict, the request handler allowing the second software configuration if the request handler finds no conflict.

19. The computer program product of claim 18, wherein the request handler includes instructions for updating the local database with installation dependencies and operational dependencies.

20. The computer program product of claim 18, wherein the request handler includes instructions for periodically monitoring a master dependency database in a server IHS for updates to the installation and operational dependencies in the local database.
